(19) United States
(12) Patent Application Publication
(10) Pub. No.: US 2020/0383145 A1
(43) Pub. Date: Dec. 3, 2020

(54) METHOD AND APPARATUS FOR RANDOM ACCESS

(71) Applicant: Telefonaktiebolaget LM Ericsson (publ), Stockholm (SE)

(72) Inventors: Rui FAN, Beijing (CN); Stefan PARKVALL, Bromma (SE); Janne PEISA, Espoo (FI)

(73) Assignee: Telefonaktiebolaget LM Ericsson (publ), Stockholm (SE)

(21) Appl. No.: 16/764,398

(22) PCT Filed: Nov. 14, 2018
(86) PCT No.: PCT/CN2018/115347

§ 371 Date: May 15, 2020

(30) Foreign Application Priority Data
Nov. 16, 2017 (CN) PCT/CN2017/111376

(51) Int. Cl. H04W 74/08; H04W 74/00

(52) U.S. Cl. CPC H04W 74/0833; H04W 74/002

(57) ABSTRACT

A method and an apparatus for random access. The method for random access implemented at a base station may comprise sending a first message for triggering random access to a terminal device, wherein the first message indicates a first UL carrier of two candidate UL carriers for the random access and receiving a random access request from the terminal device. The two candidate UL carriers include a normal uplink carrier and a supplementary uplink carrier.

### TECHNICAL FIELD

The non-limiting and exemplary embodiments of the present disclosure generally relate to wireless access technology, and in particular, to methods, apparatuses and computer program for random access.

### BACKGROUND

This section introduces aspects that may facilitate a better understanding of the disclosure. Accordingly, the statements of this section are to be read in this light and are not to be understood as admissions about what is in the prior art or what is not in the prior art.

For initial deployment of New Radio (NR), the uplink (UP) coverage could be a problem due to lack of low carrier frequency. For the time being, the low carrier frequency bands are already deployed with 2G, 3G and 4G systems. At the early stage, NR will use some unused frequency bands such as 3.5 GHz. However, compared to the coverage of frequency bands below 2 GHz, the coverage of 3.5 GHz is around 5-dB smaller. For downlink (DL) coverage, this is less of an issue as the power of NR NodeBs (gNBs) can be increased and also beamforming can be applied to ensure NR at 3.5 GHz can have a comparable coverage as Long Term Evolution (LTE). However, there may be UL coverage problem for a terminal device, as the power of terminal device is limited and the terminal device may be not equipped with good UL beamforming antennas.

In order to make sure that NR can have a comparable UL coverage as LTE, it was proposed to borrow some resources from a LTE carrier. That is, it is possible to allow LTE and NR to share one LTE UL carrier. In 3^{rd} Generation Partnership Project (3GPP), sharing of a frequency carrier such as below 2 GHz between NR system and LTE system is under discussion which is called supplementary UL (SUL) in NR.

The basic idea of SUL is that some radio resources of a carrier at low frequency which is now used by LTE system may be configured as NR SUL carrier. Because that SUL carrier is of lower frequency, the pathloss of that SUL carrier is smaller than that of the normal NR UL carrier, thus the UL coverage of a NR cell may be increased. FIG. 1 shows the SUL and normal UL coverage of a NR cell. The area 101 in shadow is covered by both SUL and normal UL. The ring area 102 is covered only by SUL. It is obvious that the UL coverage of the NR cell is increased by using the LTE UL carrier (i.e., SUL). For a terminal device in area 101, it may choose to use either SUL or normal UL for UL data transmission. For a terminal device in area 102, it may use SUL for data communication.

### SUMMARY

Various embodiments of the present disclosure mainly aim at providing methods, apparatus and computer programs for random access. Other features and advantages of embodiments of the present disclosure will also be understood from the following description of specific embodiments when read in conjunction with the accompanying drawings, which illustrate, by way of example, the principles of embodiments of the present disclosure.

According to a first aspect of the disclosure, there is provided a method for a method implemented at a base station. The method may comprise sending a first message for triggering random access to a terminal device, wherein the first message indicates a first uplink (UL) carrier of at least two candidate UL carriers for the random access; and receiving a random access request from the terminal device on the first UL carrier. The at least two candidate UL carriers are configured to the terminal device with regard to a cell served by the base station, and the at least two candidate UL carriers comprise a normal UL carrier and a Supplementary UL carrier.

In some embodiments, the first message may be one of a radio resource control (RRC) message, a physical downlink control channel (PDCCH) order and a MAC control element (CE), and the second message is one of a PDCCH order and a MAC CE.

In some embodiments, the first message may include a UL carrier indicator indicating the first UL carrier.

In some embodiments, the first UL carrier may be indicated by a UL carrier indicator in the first message.

In some embodiments, the first UL carrier may be indicated by a preamble index in the first message.

In some embodiments, the method may further comprise sending a first mapping between preamble indexes used in a PDCCH order or a MAC CE and the at least two candidate UL carriers to the terminal device.

According to a second aspect of the disclosure, there is provided a method for a method implemented at a terminal device. The method may comprise: receiving a first message for triggering random access from a base station, wherein the first message indicates a first UL carrier of at least two candidate UL carriers for the random access; determining the first UL carrier based on the first message; and sending a random access request to the base station on the first UL carrier.

In some embodiments, the first message may be one of a RRC message, a PDCCH order and a MAC CE, and the second message is one of a PDCCH order and a MAC CE.

In some embodiments, the first message may include a UL carrier indicator which indicates the first UL carrier.

In some embodiments, the UL carrier indicator is a UL carrier index or a preamble index.

According to a third aspect of the disclosure, there is provided an apparatus in a base station. The apparatus may comprise a processor and a memory. The memory may contain instructions executable by the processor, whereby the apparatus is operative to carry out the method for random access according to the first aspect of the disclosure.

According to a fourth aspect of the disclosure, there is provided an apparatus in a terminal device. The apparatus may comprise a processor and a memory. The memory may contain instructions executable by the processor, whereby the apparatus is operative to carry out the method for random access according to the second aspect of the disclosure.

According to a fifth aspect of the disclosure, there is provided an apparatus in a base station. The apparatus comprises a transmission unit configured to send a first message for triggering random access to a terminal device, the first message indicating a first UL carrier of two candidate UL carriers for the random access, and to send a second message for triggering random access to the terminal device; and a responding unit configured to respond to a random access request from the terminal device on the first UL carrier and to respond to a random access request from the terminal device on a second UL carrier of the two candidate UL carriers.

According to a sixth aspect of the disclosure, there is provided an apparatus in a terminal device. The apparatus comprises a receiving unit configured to receive a first message for triggering random access from a base station, the first message indicating a first UL carrier of two candidate UL carriers for the random access, and to receive a second message for triggering random access from the base station; a carrier determining unit configured to determine the first UL carrier based on the first message; and a random access procedure initiating unit configured to initiate a random access procedure on the first UL carrier to the base station and to initiate a random access procedure on a second UL carrier of the two candidate UL carriers with the base station.

According to a seventh aspect of the disclosure, there is provided a computer program product being tangibly stored on a computer readable storage medium. The computer program product may include instructions which, when executed on at least one processor, cause the at least one processor to carry out the method according to the first aspect of the disclosure.

According to an eighth aspect of the disclosure, there is provided a computer program product being tangibly stored on a computer readable storage medium. The computer program product may include instructions which, when executed on at least one processor, cause the at least one processor to carry out the method according to the second aspect of the disclosure.

In a ninth aspect of the present disclosure, there is provided a communication system. The communication system may comprise a host computer. The host computer may comprise processing circuitry configured to provide user data and a communication interface configured to forward the user data to a cellular network for transmission to a terminal device. The cellular network may comprise a base station having a radio interface and processing circuitry. The base station's processing circuitry may be configured to perform any of the steps of the method according to the first aspect of the disclosure.

In a tenth aspect of the disclosure, there is provided a method implemented in a communication system comprising a host computer, a base station and a terminal device. The method may comprise: at the host computer, providing user data; and at the host computer, initiating a transmission carrying the user data to the terminal device via a cellular network comprising the base station, wherein the base station performs any of the steps of the method according to the first aspect of the disclosure.

In an eleventh aspect of the disclosure, there is provided a communication system. The communication system may comprise a host computer. The host computer may comprise processing circuitry configured to provide user data and a communication interface configured to forward the user data to a cellular network for transmission to a terminal device. The terminal device may comprise a radio interface and processing circuitry. The terminal device's processing circuitry may be configured to perform any of the steps of the method according to the second aspect of the disclosure.

In a twelfth aspect of the disclosure, there is provided a method implemented in a communication system comprising a host computer, a base station and a terminal device. The method may comprise: at the host computer, providing user data; and at the host computer, initiating a transmission carrying the user data to the terminal device via a cellular network comprising the base station, wherein the terminal device performs any of the steps of the method according to the second aspect of the disclosure.

In a thirteenth aspect of the disclosure, there is provided a communication system. The communication system may comprise a host computer. The host computer may comprise a communication interface configured to receive user data originating from a transmission from a terminal device to a base station. The terminal device may comprise a radio interface and processing circuitry. The terminal device's processing circuitry may be configured to perform any of the steps of the method according to the second aspect of the disclosure.

In a fourteenth aspect of the disclosure, there is provided a method implemented in a communication system comprising a host computer, a base station and a terminal device. The method may comprise: at the host computer, receiving user data transmitted to the base station from the terminal device, wherein the terminal device performs any of the steps of the method according to the second aspect of the disclosure.

In a fifteenth aspect of the disclosure, there is provided a communication system. The communication system may comprise a host computer. The host computer may comprise a communication interface configured to receive user data originating from a transmission from a terminal device to a base station. The base station may comprise a radio interface and processing circuitry. The base station's processing circuitry may be configured to perform any of the steps of the method according to the first aspect of the disclosure.

In a sixteenth aspect of the disclosure, there is provided a method implemented in a communication system comprising a host computer, a base station and a terminal device. The method may comprise: at the host computer, receiving, from the base station, user data originating from a transmission which the base station has received from the terminal device, wherein the base station performs any of the steps of the method according to the first aspect of the disclosure.

According to the various aspects and embodiments as mentioned above, in the case of two UL carriers corresponding to one cell, random access procedure may be initiated between the base station and terminal device by using the methods according to the embodiments of the present disclosure.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates an example of a SUL and normal UL coverage of a NR cell;

FIG. 2 is a flowchart illustrating a method for random access implemented at a base station according to some embodiments of the present disclosure;

FIG. 3 is a flowchart illustrating a method for random access implemented at a terminal device according to some embodiments of the present disclosure;

FIG. 4 is a flowchart illustrating a method for maintaining UL sync implemented at a terminal device according to some embodiments of the present disclosure;

FIG. 5 is a schematic block diagram of an apparatus implemented at a base station according to some embodiments of the present disclosure;

FIG. 6 is a schematic block diagram of an apparatus implemented at a terminal device according to some embodiments of the present disclosure;

FIG. 7 is a schematic block diagram of an apparatus in a base station according to some embodiments of the present disclosure;

FIG. 8 is a schematic block diagram of an apparatus in a terminal device according to some embodiments of the present disclosure

FIG. 9 illustrates a telecommunication network connected via an intermediate network to a host computer according to some embodiments of the present disclosure;

FIG. 10 illustrates a host computer communicating via a base station with a user equipment over a plurality of wireless connection according to some embodiments of the present disclosure;

FIG. 11 illustrates a flowchart of methods in a communication system including a host computer, a base station and a user equipment according to some embodiments of the present disclosure; and

FIG. 12 illustrates a flowchart of methods in a communication system including a host computer, a base station and a user equipment according to some embodiments of the present disclosure.

### DETAILED DESCRIPTION

Some exemplary embodiments will be described in more detail with reference to the accompanying drawings, in which the exemplary embodiments of the present disclosure have been illustrated. However, the present disclosure may be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

Hereinafter, the principle and spirit of the present disclosure will be described with reference to illustrative embodiments. It should be understood, all these embodiments are given merely for one skilled in the art to better understand and further practice the present disclosure, but not for limiting the scope of the present disclosure. For example, features illustrated or described as part of one embodiment may be used with another embodiment to yield still a further embodiment. In the interest of clarity, not all features of an actual implementation are described in this specification.

References in the specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that, although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs. For example, the term “terminal device” used herein may refer to any terminal device or user equipment (UE) having wireless communication capabilities, including but not limited to, mobile phones, cellular phones, smart phones, or personal digital assistants (PDAs), portable computers, image capture devices such as digital cameras, gaming devices, music storage and playback appliances, wearable devices, vehicle-mounted wireless device and the like. In the following description, the terms “terminal device”, “user equipment” and “UE” may be used interchangeably. Similarly, the term “base station” may represent a node B (NodeB or NB), an evolved NodeB (eNodeB or eNB), a Remote Radio Unit (RRU), a radio head (RH), a remote radio head (RRH), a relay node (RN), a low power node (LPN) such as a femto, a pico, an access point (AP) and so forth.

For illustrative purposes, several embodiments of the present disclosure will be described in the context of a New Radio (NR) system. Those skilled in the art will appreciate, however, that the concept and principle of the several embodiments of the present disclosure may be more generally applicable to other wireless networks with more than one UL carrier.

It is agreed in 3GPP Radio Access Network2 (RAN2) discussion for SUL operation in connected mode that there are two ULs configured for one DL of a same cell when SUL is configured. That is, two ULs correspond to a same cell.

There are two ways to trigger random access for RRC connected terminal device in LTE, either by sending RRCConnectionReconfiguration message with mobilityControlInfo included, or by sending PDCCH order or MAC CE.

The former solution may be used for handover. The terminal device will do random access on the Primary Cell (PCell) where the terminal device monitors Radio Link Failure (RLF). The latter solution may be used when UL sync of the carrier of a Secondary Cell (SCell) is different from the PCell, and thus network sends PDCCH order via that carrier to trigger random access on that carrier.

With SUL, there will be at least two UL carriers coupled to one DL carrier, i.e. SUL together with normal UL. Then, the terminal device is not clear which carrier it needs to use to perform random access procedure. In other words, how to configure random access is a problem in such case. For connected mode, it should be based on network control to determine which UL should be used for random access procedure. However, there is no method to support this in the prior art.

For RRCConnectionReconfiguration message triggered random access, random access procedure may be triggered on PCell during handover. However, according to RAN2 agreement, both UL carriers are for the same DL, thus it is not clear which UL carrier should be selected.

For PDCCH order or MAC CE triggered random access, PDCCH order or MAC CE does not have any information about the carrier index, thus it is not clear which UL carrier should be selected either.

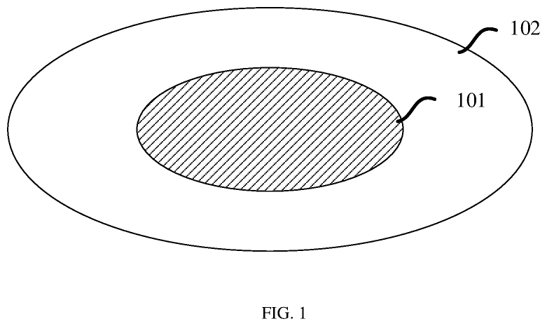

In the NR, for a terminal device in the area 101 of FIG. 1, two candidate UL carriers are available for one NR cell, thus random access procedure may be initiated on both SUL carrier and normal UL carrier, which means that the terminal device would twice be initiated random access to the NR cell, respectively through the two candidate UL carriers. In the following description, a first UL carrier refers to a UL carrier used for random access procedure with a terminal device for the first time. A second UL carrier refers to a UL carrier used for random access procedure with a terminal device for the second time. As to a PCell, the random access on the first UL carrier is triggered by a RRC message and the random access on the second UL carrier is triggered by a PDCCH order or a MAC CE. After the random access procedures with the PCell are initiated on both of the candidate UL carriers, the random access procedures to the Secondary Cell (SCell) (which provides additional wireless resources to the terminal devices on the basis of the PCell) may begin. Different from the PCell, both random accesses to the SCell through a normal UL carrier and a SUL carrier are triggered by a PDCCH order or a MAC CE.

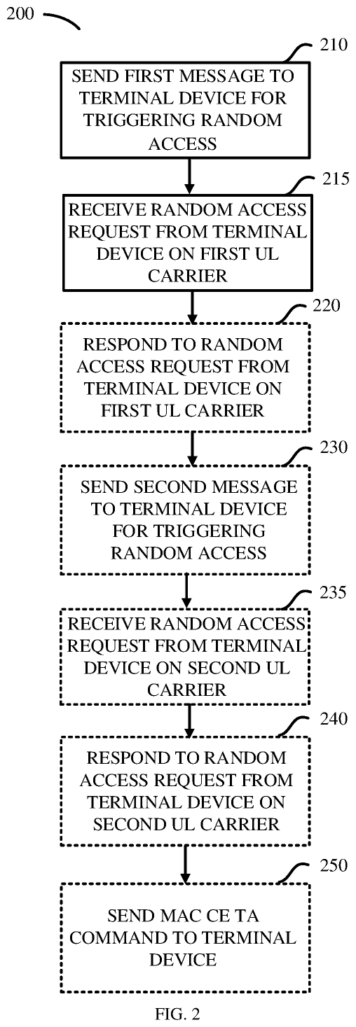

According to some embodiment of the disclosure, a method at a base station is provided. The method comprises steps of: sending a first message to a terminal device for triggering random access, and receiving a random access request from the terminal device on a first uplink carrier. The first uplink carrier is either a normal uplink carrier or a supplementary uplink carrier which are both configured to the terminal device regarding to a cell served by the base station. The method may further comprise steps after the receiving step, such as how the base station handles the random access request. An example illustrated in FIG. 2 is provided below.

FIG. 2 is a flowchart illustrating a method 200 for random access implemented at a base station according to some embodiments of the present disclosure. The base station may be, for example, a gNB operating in the NR system. Any step or feature illustrated by dashed lines should be regarded as optional.

As shown in FIG. 2, at block 210, the base station may send to a terminal device a first message for triggering random access. As to a PCell, the first message may be a RRC message. As to a SCell, the first message may be a PDCCH order or a MAC CE. In some embodiments, the first message may indicate a first UL carrier of two candidate UL carriers for random access. The following will describe how to indicate the first UL carrier for random access with respect to the RRC message, or the PDCCH order or the MAC CE, separately.

In some embodiments, the indication of the first UL carrier for random access may be explicit or implicit.

In an embodiment of explicit indication with respect to the RRC message, the first UL carrier may be indicated by a UL carrier indicator. The RRC message may include a UL carrier indicator indicating the first UL carrier. In an example, a UL carrier index field may be included in ServingCellConfigCommon of SynchronousReconfiguation in the RRC message to indicate which UL carrier should be selected for random access procedure. In an example, if the UL carrier index field is set to 0, the SUL carrier is selected for random access procedure, otherwise the normal UL carrier is selected for random access procedure. In another example, if the UL carrier index field is set to 0, the normal UL carrier is selected for random access procedure, otherwise the SUL carrier is selected for random access procedure.

In an embodiment of implicit indication with respect to the RRC message, the first UL carrier may be indicated by the UL information of the SUL carrier and the normal UL carrier. Both the SUL carrier and the normal UL carrier may be configured by RRC message. But the UL information configured for each UL carrier could be different. The first UL carrier may be configured with more UL information than the second UL carrier. In an example, the first UL carrier may be configured with full information, i.e. Physical Uplink Shared Channel (PUSCH), Physical Uplink Control Channel (PUCCH), Sounding Reference Signal (SRS) are all configured in the first UL carrier. The second UL may be configured with partial information, e.g. only PUSCH, or PUSCH and PUCCH, or PUSCH and SRS. Alternatively, both UL carriers may not be configured with full information. The first UL carrier may be configured with e.g. PUSCH and PUCCH, or PUSCH and SRS. The second UL may be configured with, e.g. only PUSCH, or PUCCH, or SRS.

In an embodiment of explicit indication with respect to the PDCCH order or the MAC CE, similar to the RRC message, the PDCCH order or the MAC CE may include a UL carrier indicator indicating the first UL carrier. In an example, a UL carrier index field can be included in the PDCCH order or the MAC CE to indicate which UL carrier should be selected for random access procedure. In an example, if the UL carrier index field is set to 0, the SUL carrier is selected for random access procedure, otherwise the normal UL carrier is selected for random access procedure. In another example, if the UL carrier index field is set to 0, the normal UL carrier is selected for random access procedure, otherwise the SUL carrier is selected for random access procedure.

In an embodiment of implicit indication with respect to the PDCCH order or the MAC CE, the first UL carrier may be indicated by a preamble index in the PDCCH order or the MAC CE. In an example, the preamble indexes used in PDCCH order or MAC CE may be classified into two groups, one group corresponds to SUL carrier, and the other group corresponds to normal UL carrier. Therefore a mapping (hereinafter referred to as a first mapping) between preamble indexes used in the PDCCH order or the MAC CE and the two candidate UL carriers may be established. The first mapping may be provided to the terminal device either in broadcasted system information or in terminal device dedicated signaling. Alternatively, the first mapping may be predefined in the terminal device. Thus when the terminal device receives the PDCCH order or the MAC CE, it may check which group this preamble index belongs to and then know which UL carrier it should use to initiate random access procedure.

In another embodiment of implicit indication with respect to the PDCCH order or the MAC CE, the first UL carrier may be indicated by a receipt timing of the PDCCH order or the MAC CE. In an example, it can be defined that different timings correspond to different UL carriers. In an example, even-numbered slots/subframes/frames may correspond to SUL carrier and odd-numbered slots/subframes/frames may correspond to normal UL carrier. Alternatively, even-numbered slots/subframes/frames may correspond to SUL carrier and odd-numbered slots/subframes/frames may correspond to normal UL carrier. Therefore a mapping (hereinafter referred to as a second mapping) between receipt timings of the first message and the two candidate UL carriers may be established. The second mapping may be provided to the terminal device via dedicated RRC signaling. Alternatively, the second mapping may be predefined in the terminal device. The receipt timing of the PDCCH order or the MAC CE may indicate the UL carrier to use.

In addition, an embodiment of indication the first UL carrier for random access with respect to the RRC message, or the PDCCH order or the MAC CE is provided by the present disclosure. In this embodiment, the first message (i.e., the RRC message, or the PDCCH order or the MAC CE) may be scrambled by a Radio Network Temporary Identifier (RNTI). A plurality of RNTIs may be allocated to the terminal device and each RNTI may be associated to one UL carrier. Therefore a mapping (hereinafter referred to as a fourth mapping) between RNTIs and the two candidate UL carriers may be established. The fourth mapping may be provided to the terminal device via a dedicated RRC signaling. Alternatively, the fourth mapping may be predefined in the terminal device. When the terminal device receives the first message, it may try to use different RNTIs to descramble the first message. The RNTI being able to descramble the first message may correspond to the first UL carrier. The terminal device may find the correspondence between this RNTI and the first UL carrier from the fourth mapping, and thus determine the first UL carrier.

At block 215, the base station may receive a random access request from the terminal device on the first UL carrier. Then, at block 220, the base station may respond to the random access request from the terminal device on the first UL carrier. In an example, the base station may send a response including a first timing advance (TA) to the terminal device. Then the terminal device may obtain initial UL sync for the first UL carrier based on the first TA.

At block 230, the base station may send a second message for triggering random access to the terminal device. In an embodiment, the second message may indicate a second UL carrier for the random access to be triggered. The second UL carrier is one of the at least two candidate UL carriers except the first UL carrier. In another embodiment, the second message may not need to indicate which UL carrier is selected this time, if there are only two candidate UL carriers and the first UL carrier may be determined at block 210. In an example, if the first UL carrier is SUL carrier, the second UL carrier is normal UL carrier. If the first UL carrier is normal UL carrier, the second UL carrier is SUL carrier. Alternatively, the second message may also indicate which UL carrier is selected by using the aforementioned methods related to the PDCCH order or the MAC CE.

At block 235, the base station may receive a random access request from the terminal device on the second UL carrier. Then, at block 240, the base station may respond to the random access request from the terminal device on the second UL carrier. In an example, the base station may send a response including a second TA to the terminal device. Then the terminal device may obtain initial UL sync for the second UL carrier based on the second TA.

Once the initial UL syncs for the two candidate UL carriers are obtained via the two random access procedures, the terminal device needs to maintain UL sync continuously. MAC CE TA command may be used to maintain continuous time alignment. However, the current MAC CE TA command doesn't indicate which UL carrier it is targeted to. In some embodiments, in a method for maintaining UL sync, a base station may send a MAC CE timing advance (TA) command to a terminal device (as shown in block 250 of FIG. 2), the MAC CE TA command indicating which UL carrier the MAC CE is targeted to. Embodiments of a method for maintaining UL sync will be described below.

In an embodiment, the receipt timing of the MAC CE TA command may be used to indicate which UL carrier this MAC CE TA command is targeted to. For example, MAC CE TA command received at even-numbered slots/subframes/frames may be for SUL carrier while MAC CE TA command received at odd-numbered slots/subframes/frames may be for normal UL carrier. Alternatively, MAC CE TA command received at even-numbered slots/subframes/frames may be for normal UL carrier while MAC CE TA command received at odd-numbered slots/subframes/frames may be for SUL carrier. Therefore a mapping (hereinafter referred to as a third mapping) between receipt timings of the MAC CE TA command and the two candidate UL carriers may be established. The third mapping may be provided to the terminal device via a dedicated RRC signaling. Alternatively, the third mapping may be predefined in the terminal device.

In another embodiment, the RNTI used to scramble the MAC CE TA command may be used to indicate which UL carrier this MAC CE TA command is targeted to. As described above, a plurality of RNTIs may be allocated to the terminal device and each RNTI may be associated to one UL carrier. When the terminal device receives the MAC CE TA command, it may use different RNTIs to descramble the MAC CE TA command. The RNTI being able to descramble the MAC CE TA command may correspond to one UL carrier. The terminal device may find the correspondence between this RNTI and that UL carrier from the fourth mapping, and thus determine which UL carrier this TA command is targeted to.

The method for maintaining UL sync may be individual or in combination with the method 200 shown in FIG. 2.

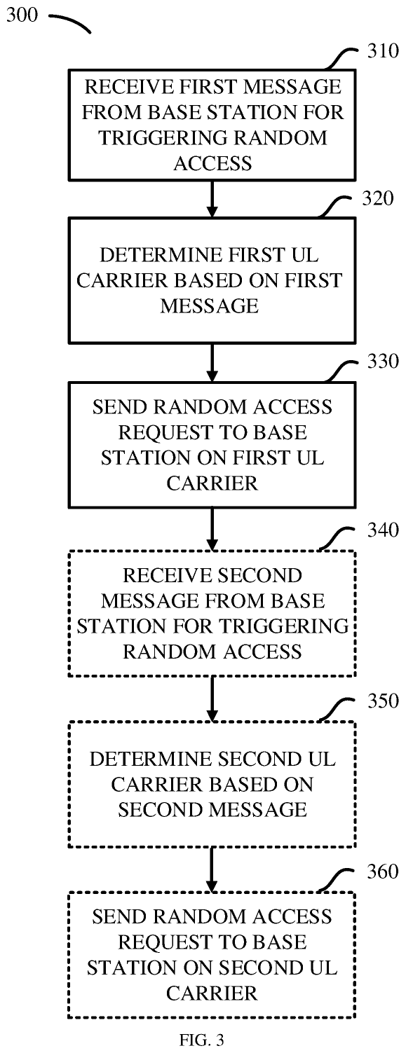

According to some embodiment of the disclosure, a method at a terminal device is provided. The method comprises steps of: receiving a first message from a base station for triggering random access, wherein the first message indicates a first uplink carrier of either a normal uplink carrier or a supplementary uplink carrier which are both configured to the terminal device regarding to a cell served by the base station; determining the first UL carrier based on the first message; and sending a random access request to the base station on the first uplink carrier. The method may further comprise steps after the sending of the random access request. An example illustrated in FIG. 3 is provided below.

FIG. 3 is a flowchart illustrating a method 300 for random access implemented at a terminal device according to some embodiments of the present disclosure. The terminal device may be any type of device capable of wireless communication, and it may also be referred to as UE or terminal.

As shown in FIG. 3, at block 310, the terminal device may receive a first message for triggering random access from a base station. The first message may indicate a first UL carrier of two candidate UL carriers for random access. As to a PCell, the first message may be a RRC message. As to a SCell, the first message may be a PDCCH order or a MAC CE. The methods of indicating a first UL carrier of two candidate UL carriers for random access are described as above.

At block 320, the terminal device may determine the first UL carrier based on the first message.

In an embodiment, if the first UL carrier is indicated by a UL carrier indicator in the first message, the terminal device may obtain the UL carrier indicator and determine the first UL carrier based on the UL carrier indicator. The principle of determining the first UL carrier depends on how the UL carrier indicator is defined. In an example, when the UL carrier indicator is set to 0, the SUL carrier is selected for random access procedure. The terminal device will recognize the first UL carrier as a SUL carrier if it finds a “0” in the field of the UL carrier indicator; otherwise it will recognize the first UL carrier as a normal UL carrier. Alternatively, when the UL carrier indicator is set to 0, the normal UL carrier is selected for random access procedure. The terminal device will recognize the first UL carrier as a normal UL carrier if it finds a “0” in the field of the UL carrier indicator; otherwise it will recognize the first UL carrier as a SUL carrier.

In an embodiment, if the first UL carrier is indicated by UL information of the SUL carrier and the normal UL carrier, the terminal device may obtain UL information of the two candidate UL carriers from the first message, and then determine the UL carrier with more UL information as the first UL carrier.

In an embodiment, if the first UL carrier is indicated by a preamble index in the PDCCH order or the MAC CE, the terminal device may obtain a preamble index in the first message, and determine the first UL carrier corresponding to the preamble index based on the first mapping and the two candidate UL carriers. The first mapping may be informed to the terminal device either in broadcasted system information or in terminal device dedicated signaling Alternatively, the first mapping may be predefined in the terminal device. Thus when the terminal device receives the PDCCH order or the MAC CE, it may determine the first UL carrier corresponding to the preamble index based on the first mapping.

In an embodiment, if the first UL carrier is indicated by a receipt timing of the PDCCH order or the MAC CE, the terminal device may obtain a receipt timing of the first message, and determine the first UL carrier based on the receipt timing. When the terminal device receives the PDCCH order or the MAC CE, it may determine a UL carrier corresponding to the receipt timing of the first message in the second mapping, and determine it as the first UL carrier. The second mapping may be informed to the terminal device either in broadcasted system information or in terminal device dedicated signaling. Alternatively, the second mapping may be predefined in the terminal device. In an example, it is defined that even-numbered slots correspond to SUL carrier and odd-numbered slots correspond to normal UL carrier. When the terminal device receives the PDCCH order or the MAC CE on even-numbered slots, it may determine the first UL carrier as a SUL carrier. When the terminal device receives the PDCCH order or the MAC CE on odd-numbered slots, it may determine the first UL carrier as a normal UL carrier.

In an embodiment, if the first UL carrier is indicated by the RNTI used to scramble/descramble the first message, the terminal device may determine a RNTI for the first message. In an example, the terminal device may use different RNTIs to descramble the first message so as to determine the RNTI corresponding to the first message. Then, the terminal device determines the first UL carrier corresponding to the RNTI for the first message based on the fourth mapping. The fourth mapping may be sent to the terminal device via a dedicated RRC signaling. Alternatively, the fourth mapping may be predefined in the terminal device.

At block 330, the terminal device may send a random access to the base station on the first UL carrier. In an example, the terminal device may send a random access request to the base station, and then it may receive a response including a first TA to the terminal device. Then the terminal device may obtain initial UL sync for the first UL carrier based on the first TA.

At block 340, the terminal device may receive a second message for triggering random access from the base station. Since there are only two candidate UL carriers, the second UL carrier is the UL carrier other than the first carrier. The terminal device may determine the second UL carrier upon receiving the second message. In an example, if the first UL carrier is SUL carrier, the second UL carrier is normal UL carrier. If the first UL carrier is normal UL carrier, the second UL carrier is SUL carrier. Alternatively, the terminal device may also use the aforementioned methods to analyze the second message to determine the second UL carrier, if the second message indicates the second UL carrier.

At block 350, the terminal device may determine the second UL carrier based on the second message. The process of determining the second UL carrier based on the second message may be similar to the process as described at block 320.

At block 360, the terminal device may initiate a random access procedure on a second UL carrier of the two candidate UL carriers to the base station. In an example, the terminal device may send a random access request to the base station, and then it may receive a response including a second TA to the terminal device. Then the terminal device may obtain initial UL sync for the second UL carrier based on the second TA.

FIG. 4 is a flowchart illustrating a method 400 for maintaining UL sync implemented at a terminal device according to some embodiments of the present disclosure. As shown in FIG. 4, at block 410, the terminal device may receive a MAC CE TA command from the base station. The MAC CE TA command may indicate which UL carrier the MAC CE is targeted to.

At block 420, the terminal device may determine a UL carrier based on the MAC CE TA command.

In an embodiment, if the UL carrier is indicated by the receipt timing of the MAC CE TA command, the terminal device may determine a receipt timing of the MAC CE TA command. Then, the terminal device may determine the UL carrier corresponding to the receipt timing of the MAC CE TA command. The third mapping may be sent to the terminal device via a dedicated RRC signaling. Alternatively, the third mapping may be predefined in the terminal device. The terminal device may determine the UL carrier corresponding to the receipt timing of the MAC CE TA command based on the third mapping.

In another embodiment, if the UL carrier is indicated by the RNTI used to scramble/descramble the MAC CE TA command, the terminal device may determine a RNTI for the MAC CE TA command. In an example, the terminal device may use different RNTIs to descramble the MAC CE TA command so as to determine the RNTI corresponding to the MAC CE TA command. Then, the terminal device may determine the UL carrier corresponding to the RNTI based on the fourth mapping. The fourth mapping may be sent to the terminal device via a dedicated RRC signaling. Alternatively, the fourth mapping may be predefined in the terminal device.

At block 430, the terminal device may update TA for the determined UL carrier. In this way, the UL sync for the UL carrier may be maintained.

The method 400 for maintaining UL sync implemented at a terminal device may be in combination with the method as shown in FIG. 3, or may be individual.

According to the various aspects and embodiments as mentioned above, in the case of two UL carriers corresponding to one cell in NR, random access procedure may be initiated between the base station and terminal device by using the methods according to the embodiments of the present disclosure, thereby increasing the UL coverage of NR.

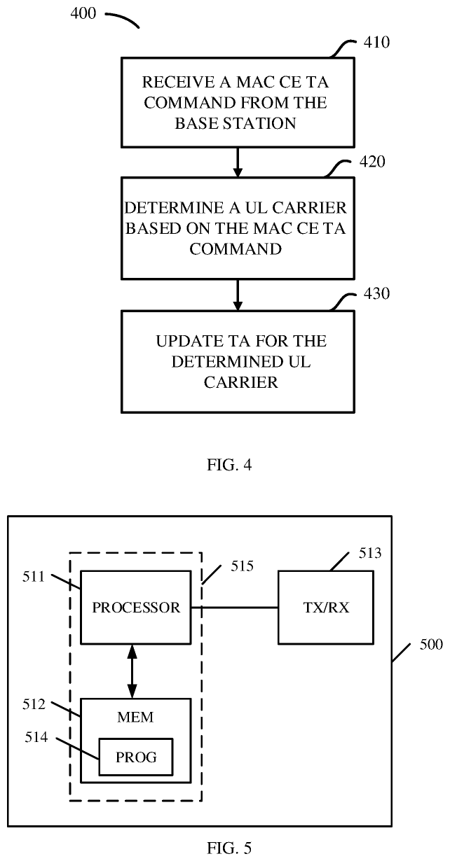

FIG. 5 illustrates a simplified block diagram of an apparatus 500 that may be implemented at a base station, e.g., a gNB in the NR system. As shown in FIG. 5, the apparatus 500 may comprise at least one processor 511, such as a data processor (DP) and at least one memory (MEM) 512 coupled to the processor 511. The apparatus 500 may further comprise a transmitter TX and receiver RX 513 coupled to the processor 511. The MEM 512 stores a program (PROG) 514. The PROG 514 may include instructions that, when executed on the associated processor 511, enable the apparatus 500 to send a first message for triggering random access to a terminal device, wherein the first message indicates a first uplink (UL) carrier of two candidate UL carriers for the random access; to respond to a random access request from the terminal device on the first UL carrier; to send a second message for triggering random access to the terminal device; and to respond to a random access request from the terminal device on a second UL carrier of the two candidate UL carriers. A combination of the at least one processor 511 and the at least one MEM 512 may form processing means 515 adapted to implement various embodiments of the present disclosure.

The processor 511 may be of any type suitable to the local technical environment, and may include one or more of general purpose computers, special purpose computers, microprocessors, digital signal processors DSPs and processors based on multicore processor architecture, as non-limiting examples.

The MEM 512 may be of any type suitable to the local technical environment and may be implemented using any suitable data storage technology, such as semiconductor based memory devices, magnetic memory devices and systems, optical memory devices and systems, fixed memory and removable memory, as non-limiting examples.

In some embodiments, the apparatus 500 may be further operative to include a UL carrier indicator indicating the first UL carrier in the first message.

In some embodiments, the apparatus 500 may be further operative to configure the first UL carrier with more UL information than the second UL carrier.

In some embodiments, the apparatus 500 may be further operative to indicate the first UL carrier by a preamble index in the first message.

In some embodiments, the apparatus 500 may be further operative to send a first mapping between preamble indexes used in a PDCCH order or a MAC CE and the two candidate UL carriers to the terminal device.

In some embodiments, the apparatus 500 may be further operative to send a second mapping between receipt timings of the first message and the two candidate UL carriers to the terminal device.

In some embodiments, the apparatus 500 may be further operative to send a MAC CE TA command to the terminal device, the MAC CE TA command indicating which UL carrier the MAC CE is targeted to.

In some embodiments, the apparatus 500 may be further operative to send a third mapping between receipt timings of the MAC CE TA command and the two candidate UL carriers to the terminal device.

In some embodiments, the apparatus 500 may be further operative to send a fourth mapping between RNTIs and the two candidate UL carriers to the terminal device.

Various embodiments of the present disclosure may be implemented by computer program executable by one or more of the processor 611, software, firmware, hardware or in a combination thereof.

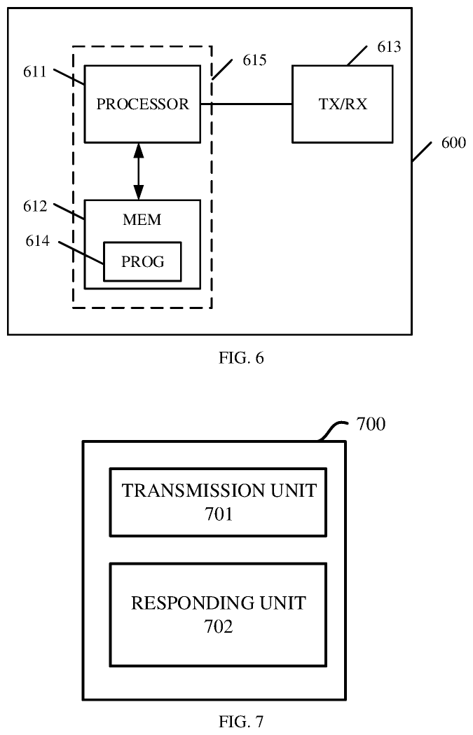

FIG. 6 illustrates a simplified block diagram of an apparatus 600 that may be embodied in/as a terminal device, e.g., a user equipment (UE). As shown in FIG. 6, the apparatus 600 comprises at least one processor 611, such as a DP, and at least one MEM 612 coupled to the processor 611. The apparatus 600 may further comprise a suitable TX/RX 613 coupled to the processor 611. The MEM 612 stores a PROG 614. The PROG 614 may include instructions that, when executed on the associated processor 611, enable the apparatus 600 to receive a first message for triggering random access from a base station, the first message indicating a first UL carrier of two candidate UL carriers for the random access; to determine the first UL carrier based on the first message; to initiate a random access procedure on the first UL carrier to the base station; to receive a second message for triggering random access from the base station; and to initiate a random access procedure on a second UL carrier of the two candidate UL carriers with the base station. A combination of the at least one processor 611 and the at least one MEM 612 may form processing means 615 adapted to implement various embodiments of the present disclosure.

The processor and 611 may be of any type suitable to the local technical environment, and may include one or more of general purpose computers, special purpose computers, microprocessors, digital signal processors DSPs and processors based on multicore processor architecture, as non-limiting examples.

The MEM 612 may be of any type suitable to the local technical environment and may be implemented using any suitable data storage technology, such as semiconductor based memory devices, magnetic memory devices and systems, optical memory devices and systems, fixed memory and removable memory, as non-limiting examples.

In some embodiments, the apparatus 600 may be further operative to include a UL carrier indicator which indicates the first UL carrier in the first message.

In some embodiments, the apparatus 600 may be further operative to obtain UL information of the two candidate UL carriers from the first message; and to determine the UL carrier with more UL information as the first UL carrier for prioritized random access.

In some embodiments, the apparatus 600 may be further operative to obtain a preamble index in the first message; and to determine the first UL carrier corresponding to the preamble index.

In some embodiments, the apparatus 600 may be further operative to obtain a receipt timing of the first message; and to determine the first UL carrier based on the receipt timing.

In some embodiments, the apparatus 600 may be further operative to determine a RNTI for the first message; and to determine the first UL carrier corresponding to the RNTI for the first message.

In some embodiments, the apparatus 600 may be further operative to receive a MAC CE TA command from the base station, the MAC CE TA command indicating which UL carrier the MAC CE is targeted to; to determine a UL carrier based on the MAC CE TA command; and to update TA for the determined UL carrier.

In some embodiments, the apparatus 600 may be further operative to determine a receipt timing of the MAC CE TA command; and to determine the UL carrier corresponding to the receipt timing of the MAC CE TA command.

In some embodiments, the apparatus 600 may be further operative to determine a RNTI for the MAC CE TA command; and to determine the UL carrier corresponding to the RNTI for the MAC CE TA command.

Various embodiments of the present disclosure may be implemented by computer program executable by one or more of the processor 611, software, firmware, hardware or in a combination thereof.

Reference is now made to FIG. 7, which illustrates a schematic block diagram of an apparatus 700 in a base station. The base station may be, for example, a gNB in the NR system. The apparatus 700 is operable to carry out the exemplary method 200 described with reference to FIG. 2 and possibly any other processes or methods. It is also to be understood that the method 200 is not necessarily carried out by the apparatus 700. At least some steps of the method 200 can be performed by one or more other entities.

As shown in FIG. 7, the apparatus 700 may comprise a transmission unit 701 configured to send a first message for triggering random access to a terminal device, the first message indicating a first UL carrier of two candidate UL carriers for the random access, and to send a second message for triggering random access to the terminal device, and a responding unit 702 configured to respond to a random access request from the terminal device on the first UL carrier and to respond to a random access request from the terminal device on a second UL carrier of the two candidate UL carriers.

In some embodiments, the transmission unit 702 may be further configured to send a MAC CE timing advance (TA) command to the terminal device, the MAC CE TA command indicating which UL carrier the MAC CE is targeted to.

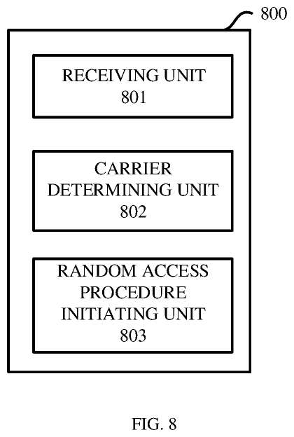

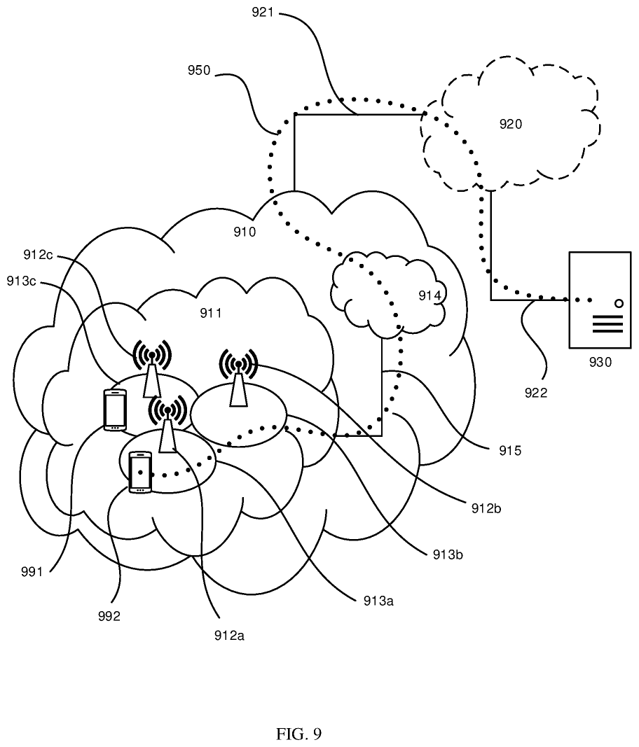

Reference is now made to FIG. 8, which illustrates a schematic block diagram of an apparatus 800 in a terminal device. The terminal device may be any type of device capable of wireless communication, and it may also be referred to as UE or terminal. The apparatus 800 is operable to carry out the exemplary method 300 described with reference to FIG. 3 and possibly any other processes or methods. It is also to be understood that the method 300 is not necessarily carried out by the apparatus 800. At least some steps of the method 300 can be performed by one or more other entities.

As shown in FIG. 8, the apparatus 800 may comprise a receiving unit 801 configured to receive a first message for triggering random access from a base station, the first message indicating a first UL carrier of two candidate UL carriers for the random access, and to receive a second message for triggering random access from the base station; a carrier determining unit 802 configured to determine the first UL carrier based on the first message; and a random access procedure initiating unit 803 configured to initiate a random access procedure on the first UL carrier to the base station and to initiate a random access procedure on a second UL carrier of the two candidate UL carriers with the base station.

In some embodiments, the receiving unit 801 may be further configured to receive a MAC CE TA command from the base station, the MAC CE TA command indicating which UL carrier the MAC CE is targeted to; to determine a UL carrier based on the MAC CE TA command; and to update TA for the determined UL carrier.

With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

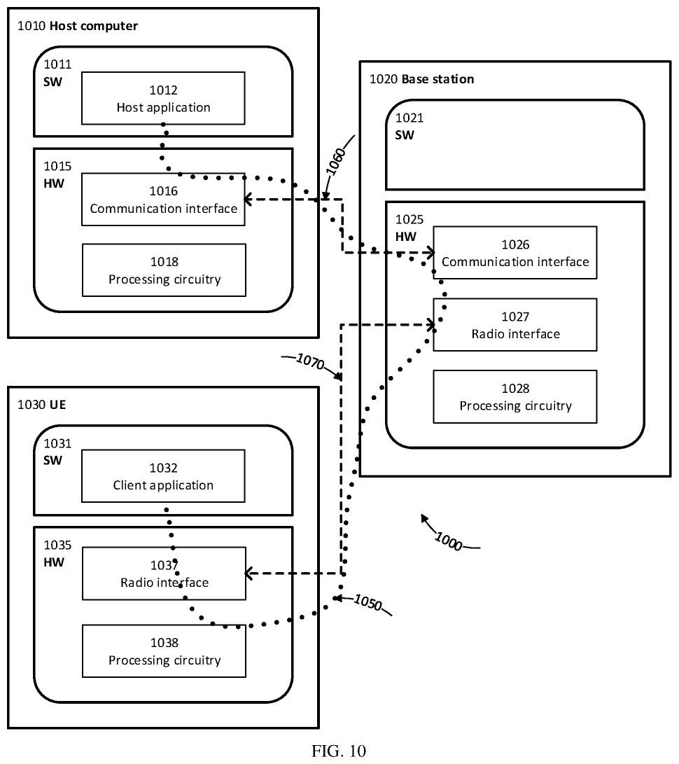

Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment. More precisely, the teachings of these embodiments may improve the UL coverage of NR by using SUL and thereby provide benefits such as better user experience.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

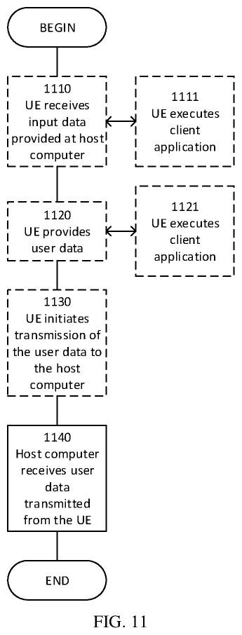

FIG. 11 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

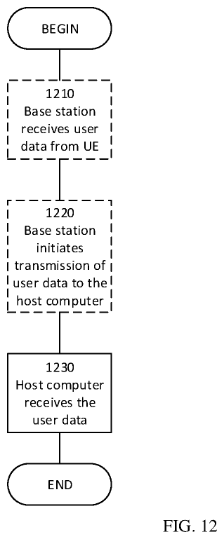

FIG. 12 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method at a base station, comprising:
sending a first message to a terminal device for triggering a random access procedure, wherein the first message indicates a first uplink (UL) carrier for the random access procedure, the first UL carrier being one of at least two candidate UL carriers configured to the terminal device with regard to a cell served by the base station, the at least two candidate UL carriers comprising a normal UL carrier and a Supplementary UL carrier, and wherein the first message is a physical downlink control channel (PDCCH) order and the first message includes an UL carrier indicator indicating the first UL carrier; and
in response to sending the first message, receiving a random access request from the terminal device on the first UL carrier.

2-3. (canceled)

4. The method according to claim 1, wherein the first message includes an UL carrier indicator field which carries the UL carrier indicator, and wherein the UL carrier indicator is an UL carrier index or a preamble index.

5. The method according to claim 4, when the UL carrier indicator is the preamble index, the method further comprising:
prior to sending the first message, sending a first mapping between preamble indexes used in a PDCCH order and the at least two candidate UL carriers to the terminal device.

6-8. (canceled)

9. A method at a terminal device comprising:
receiving a first message from a base station for triggering a random access procedure, wherein the first message indicates a first uplink (UL) carrier for the random access procedure, the first UL carrier being one of at least two candidate UL carriers configured to the terminal device with regard to a cell served by the base station, the at least two candidate UL carriers comprising a normal UL carrier and a Supplementary UL carrier, and wherein the first message is a physical downlink control channel (PDCCH) order and the first message includes an UL carrier indicator indicating the first UL carrier;
determining the first UL carrier based on the first message; and
sending a random access request to the base station on the first UL carrier.

10-11. (canceled)

12. The method according to claim 9, wherein the first message includes an UL carrier indicator field which carries the UL carrier indicator, and wherein the UL carrier indicator is an UL carrier index or a preamble index, and
wherein determining the first UL carrier based on the first message comprises:
obtaining the UL carrier indicator and determining the UL carrier according to the UL carrier indicator.

13-14. (canceled)

15. The method according to claim 9, further comprising:
receiving a second message from the base station for triggering the random access procedure, wherein the second message indicates a second UL carrier for the random access to be triggered;
determining the second UL carrier based on the second message, wherein the second UL carrier is one of the at least two candidate UL carriers except the first UL carrier; and
sending a random access request to the base station on the second UL carrier.

16. An apparatus in a base station comprising:
a processor; and
a memory containing instructions which, when executed by said processor, cause said apparatus to operate to:
send a first message to a terminal device for triggering random access procedure, wherein the first message indicates a first uplink (UL) carrier for the random access procedure, the first UL carrier being one of at least two candidate UL carriers configured to the terminal device with regard to a cell served by the base station, the at least two candidate UL carriers comprising a normal UL carrier and a Supplementary UL carrier, and wherein the first message is a physical downlink control channel (PDCCH) order and the first message includes an UL carrier indicator indicating the first UL carrier; and
receive a random access request from the terminal device on the first UL carrier, in response to the first message.

17. An apparatus in a terminal device comprising:
a processor; and
a memory containing instructions which, when executed by said processor, cause said apparatus to operate to:
receive a first message from a base station for triggering random access procedure, wherein the first message indicates a first UL carrier for the random access procedure, the first UL carrier being one of at least two candidate UL carriers configured to the terminal device with regard to a cell served by the base station, the at least two candidate UL carriers comprising a normal UL carrier and a Supplementary UL carrier, and wherein the first message is a physical downlink control channel (PDCCH) order and the first message includes an UL carrier indicator indicating the first UL carrier;
determine the first UL carrier based on the first message; and
send a random access request to the base station on the first UL carrier.

18-19. (canceled)

20. The apparatus according to claim 16, wherein the first message includes an UL carrier indicator field which carries the UL carrier indicator, and wherein the UL carrier indicator is an UL carrier index or a preamble index.

21. The apparatus according to claim 20, wherein when the UL carrier indicator is the preamble index, the apparatus is further operative to:
send a first mapping between preamble indexes used in a PDCCH order and the at least two candidate UL carriers to the terminal device, prior to sending the first message to the terminal device.

22-23. (canceled)

24. The apparatus according to claim 17, wherein the first message includes an UL carrier indicator field which carries the UL carrier indicator, and wherein the UL carrier indicator is an UL carrier index or a preamble index, and the apparatus is further operative to:
obtain the UL carrier indicator and determine the UL carrier according to the UL carrier indicator.

25. The apparatus according to claim 24, wherein the apparatus is further operative to:
receive from the base station a first mapping between UL carrier indexes or preamble indexes used in PDCCH order and the at least two candidate UL carriers, prior to receiving the first message.
